(19) United States
(12) Patent Application Publication
(10) Pub. No.: US 2005/0215674 A1
(43) Pub. Date: Sep. 29, 2005

(54) Stabilizer combination for halogen-containing thermoplastic resin compositions

(75) Inventors: Michael Rosenthal, Munchen (DE); Alfred Kurzinger, Karlsfeld (DE); Walter Reith, Odelzhausen (DE)

Correspondence Address: MICHAEL BEST & FRIEDRICH, LLP, 100 E WISCONSIN AVENUE, MILWAUKEE, WI, 53202, US

(73) Assignee: Barlocher GmbH, Unterschleissheim (DE)

(21) Appl. No.: 11/104,364

(22) Filed: Apr. 12, 2005

Related U.S. Application Data
(63) Continuation of application No. 09/937,647, filed on Jan. 29, 2002, now abandoned.

(30) Foreign Application Priority Data
Mar. 31, 1999 (DE) 19914798.1

(51) Int. Cl. C08J 3/00

(52) U.S. Cl. 524/84; 524/83; 524/110; 524/111; 524/178; 524/180

(57) ABSTRACT

A stabilizer combination for weathering-resistant-halogen-containing thermoplastic resin compositions, in particular those based on polyvinyl chloride (or PVC) is described, encompassing calcium chloride and/or calcium oxide with a particle size of not more than 200 μm, an organotin compound and at least one zinc compound selected from liquid and solid zinc salts of saturated, unsaturated, straight-chain, or branched mono- or polyfunctional aromatic or aliphatic carboxylic acids, zinc oxide and zinc hydroxide, which contains no perchlorate.

The present invention relates to a stabilizer combination for weathering-resistant halogen-containing thermoplastic resin compositions, in particular those based on polyvinyl chloride (PVC), and encompassing calcium chloride and/or calcium oxide, surface-modified where appropriate, an organotin compound and a zinc compound.

Halogen-containing polymers are subject to chemical degradation reactions resulting from exposure to electromagnetic radiation and/or heat, and these can lead to lasting impairment of performance characteristics, or lead to problems at an earlier stage, during processing. In particular, PVC moldings have a tendency toward degradation reactions brought about by heat, water, or electromagnetic radiation, and leading to impairment of properties, especially of color. A long-standing practice has been to incorporate what are known as stabilizers into these thermoplastic polymer compositions, to inhibit these undesirable degradation reactions of the polymer chains.

When producing moldings from rigid PVC (UPVC), for example window profiles, technical profiles, pipes, or sheets, it is usual to use heavy-metal-containing stabilizers, since high requirements are placed upon these moldings and these stabilizers are highly effective. Since there is currently discussion concerning the safety-at-work and environmental aspects of heavy metals such as lead and cadmium, attempts are being made to increase the extent to which these stabilizers are replaced by stabilizer systems based on calcium compounds or on zinc compounds and presenting no physiological hazard. Good results can be achieved with these calcium compounds and zinc compounds if they are used together with suitable additives, such as hydrotalcites, zeolites, hydrocalumites, polyols, diketones, aminouracils, cyanurates, or esters. of phosphorous acid.

DE-A-2935689 describes calcium hydroxide as a stabilizer component for plasticized PVC (PPVC), another essential stabilizer component needed here being at least one phenolic antioxidant. EP-B-0394547 discloses the combination of overbased alkaline earth metal carboxylates with zeolite, calcium hydroxide, and perchlorates. However, the combination described there is only suitable for use in PPVC for the indoor sector. This also applies to the stabilizers described in DE-A- 4031401. DD-A-298799 describes a combination of zinc soaps with various finely dispersed calcium compounds which are coated with calcium stearate, as a stabilizer for plasticized PVC.

Alongside stabilizer systems based on lead and calcium/zinc, it has long been known that organotin compounds may be used. An example described in U.S. Pat. No. 5,739,118 is a stabilizer combination of organotin compounds with phosphorus-containing compounds, and U.S. Pat. No. 5,518,662 describes a mixture of methyl- and butyltin compounds, and U.S. Pat. No. 3,933,743 describes various organotin compounds with low tin content. The compounds used are mostly liquid sulfur-containing organotin compounds. These substances have a strong intrinsic odor, and complicated ventilation measures have to be implemented at all stages of preparation and processing. A disadvantage with the use of these organotin compounds is that, compared with systems based on lead or calcium/zinc, they give less weathering resistance. Attempts have been made to compensate for this disadvantage by using a markedly increased concentration of pigment. The highly abrasive nature of the titanium dioxide grades usually used as pigments means that increased wear is found on machinery and tooling.

It is an object of the invention to provide a stabilizer combination for halogen-containing thermoplastic resins which, when compared with the known formulations, gives higher thermal stability and is preferably suitable for use in UPVC for the outdoor sector.

According to the invention, this object is achieved by way of a stabilizer combination for halogen-containing thermoplastic resins, encompassing:

a) calcium oxide and/or calcium hydroxide, where these may, where appropriate, have been surface-modified;

b) at least one tin compound of the general formula (I)
RₙSn(X—R′)₄₋ₙ (I)
where n is 1 or 2;
each of the groups R, which may be identical or different, is a straight-chain or branched alkyl group having from 1 to 22 carbon atoms;
each of the groups X, which may be identical or different, is —S—or —O—; and
each of the groups R′, which may be identical or different, is a straight-chain or branched alkyl group having from 1 to 22 carbon atoms, or a —[C(O)]ₘ—L—C(O)—O—R″ group or a —[C(O)]ₘ—L—O—C(O)—R″ group, where m is 0 or 1, —L— is a divalent connecting group which is selected from alkylene groups having from 1 to 4 carbon atoms, or a vinylene group, and R″ is an alkyl group having from 1 to 22 carbon atoms; or
two (X—R′) groups may have bonding to one another to form a heterocyclic ring of the formula (I′) or (I″) 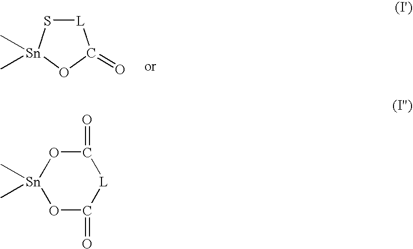
where L is as defined above; and

c) at least one zinc compound selected from liquid and solid zinc salts of saturated, unsaturated, straight chain, or branched mono- or polyfunctional aromatic or aliphatic carboxylic acids, zinc oxide and zinc hydroxide;

with the proviso that no perchlorate is present in the stabilizer combination.

The present invention also provides a thermoplastic resin composition which comprises at least one halogen-containing thermoplastic resin and the stabilizer combination of the invention.

The invention is described in more detail below with reference to preferred embodiments.

The calcium hydroxide and/or calcium oxide used as component (a) in the stabilizer combination of the invention preferably has a particle size of not more than 200 μm, in particular from 1 to 20 μm, determined by laser diffraction, method Barlocher malve-01. The calcium hydroxide and/or calcium oxide may, where appropriate, have been surface-modified. The surface modification may take place by known processes and using conventional coating agents. Preferred coating agents are fatty acids.

The amount of component (a) in the stabilizer combination of the invention is preferably from 0.1 - 5 parts by weight, in particular from 0.2 - 2 parts by weight.

Preferred tin compounds used as component (b) of the stabilizer combination of the invention and having the general formula (I) are described below:

R in the formula (I) is preferably an alkyl group having from 1 to 8 carbon atoms, particularly preferably a straight-chain alkyl group, such as a methyl, ethyl, n-propyl, n-butyl, or n-octyl group.

In one preferred embodiment of the invention, R′ in the general formula (I) is preferably an alkyl group having from 8 to 18 carbon atoms, or a —[C(O)]ₘ—L—C(O)—O—R″ group or a —[C(O)]ₘ—L—O—C(O)—R″ group, where —L— is a methylene, ethylene, or vinylene group, and R″ is an alkyl group having from 6 to 12 carbon atoms. R′ [prime] is particularly preferably a straight-chain alkyl group, such as an n-hexyl, n-heptyl, n-octyl, n-nonyl, n-decyl, n-undecyl, or n-dodecyl group.

In another preferred embodiment of the invention, two (X—R′) groups have bonding to one another to form a heterocyclic ring of the formula (I′) or (I″), where —L— is an ethylene group or a vinylene group.

Preferred examples of tin compounds of the formula (I) are methyltin trithioglycolate, dimethyltin dithioglycolate, n-butyltin trithioglycolate, di-n-butyltin dithioglycolate, n-octyltin trithioglycolate, di-n-octyltin dithioglycolate, reverse methyltin trithioesters, reverse dimethyltin dithioesters, di-n-butyltin thiopropionate, di-n-butyltin maleate, di-n-butyltin dimaleate, di-n-octyltin dimaleate, and di-n-butyltin dimercaptides.

Particularly preferred tin compounds of the formula (I) are:

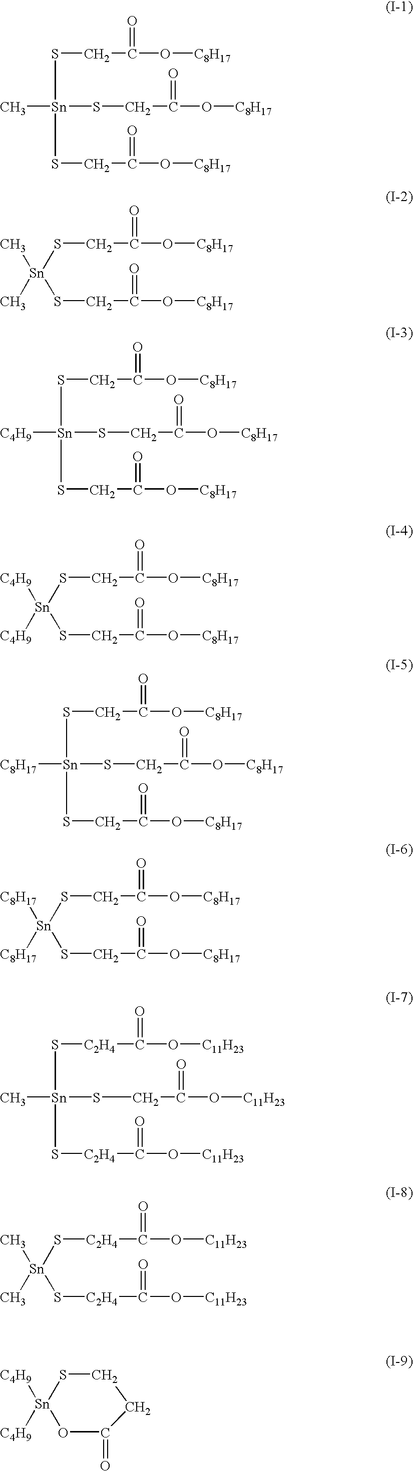

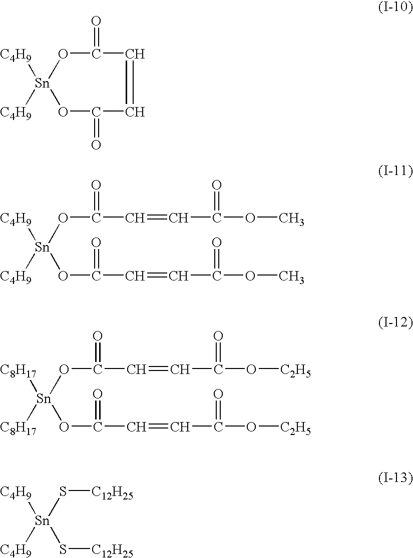

The amount of component (b) present in the stabilizer combination of the invention is preferably from 0.1-3 parts by weight, in particular from 0.2-2 parts by weight.

Component (c) of the stabilizer combination of the invention is at least one zinc compound selected from liquid and solid zinc salts of saturated, unsaturated, straight-chain, or branched, mono- or polyfunctional, aromatic or aliphatic carboxylic acids, zinc oxide, and zinc hydroxide. The component (c) used preferably comprises a zinc salt of a saturated aliphatic carboxylic acid having from 10 to 18 carbon atoms. Examples of these encompass zinc laurate and zinc stearate.

The amount of component (c) present in the stabilizer combination of the invention is preferably from 0.1-3 parts by weight, in particular from 0.5-1.5 parts by weight.

The amount used of the stabilizer combination of the invention is preferably from 0.8 to 5.5 parts by weight, in particular from 1.1 to 5.5 parts by weight, based on 100 parts by weight of the halogen-containing thermoplastic resin.

The halogen-containing thermoplastic resin for which the stabilizer combination of the invention is preferably used is polyvinyl chloride (PVC).

The term polyvinyl chloride used in the present specification encompasses commonly used homo- and copolymers of vinyl chloride, and also blends of polyvinyl chloride compounds of this type with other polymer compositions. Polymers of this type may have been prepared in any desired manner, for example by suspension, emulsion, or block polymerization. Examples of their K value are from 50 to 100.

It has been found that the use of a stabilizer combination of the invention permits the production of UPVC moldings which have unexpectedly high heat resistance combined with excellent weathering resistance, for use in outdoor applications.

Besides the abovementioned components (a), (b), and (c), the stabilizer combination of the invention may also comprise other constituents. Preferred examples of other constituents encompass:

(d) basic calcium aluminum hydroxyphosphites of the general formula (II)

$${Ca}_{x} {{A1}_{2} ( OH )}_{2 ( x + 3 - y )} {( {HPO}_{3} )}_{y} \cdot m {H}_{2} O \\ where \\ \frac{2 x + 5}{2} > y > 0 and 0 \leq m \leq 12. \qquad ( II )$$

Compounds of the general formula (II) are described by way of example in DE 4106411.

(e) Basic calcium aluminum hydroxycarboxylates of the general formula (III)

$${Ca}_{x} {{A1}_{2} ( OH )}_{[ ( 2 x + 6 ) - y ]} {A}_{y / {n}^{n -}} \cdot m {H}_{2} O \\ where \\ 2 \leq \times \leq 12 , \frac{2 x + 5}{2} > y > 0 , 0 \leq m \leq 12 , and 1 \leq n \leq 8 , and \qquad ( III )$$

Aⁿ⁻ is an aliphatic saturated, unsaturated, straight-chain or branched, monofunctional or polyfunctional carboxylic anion having from 1 to 22 carbon atoms, or an aromatic or heteroaromatic mono- or polyfunctional carboxylic anion having from 6 to 20 carbon atoms.

The carboxylic anion Aⁿ⁼⁻ of the general formula (III) may be selected from anions of malonic, succinic, adipic, fumaric, maleic, phthalic, isophthalic, terephthalic, pyridinic, benzoic, salicylic, tartronic, malic, tartaric, acetonedicarboxylic, oxoacetic, aconitic, and citric acid, for example. Preference is given to the anions of fumaric and phthalic acid, and use is particularly made of fumarates.

Compounds of the general formula (III) are known from DE 4106404.

(f) Polyols and/or disaccharide alcohols, such as trimethylolpropane, ditrimethylolpropane, pentaerythritol, dipentaerythritol, tripentaerythritol, polyvinyl alcohol, maltitol, isomaltitol, sorbitol, mannitol, lactitol, glycerol, diglycerol.

(g) Epoxy compounds based on vegetable or animal oils, for example epoxidized soy oil or rapeseed oil, epoxidized fatty esters, epoxidized glycidyl ethers, glycidyl acrylate, glycidyl methacrylate, their polymers and copolymers, and epoxidized polymers, such as epoxidized polybutadiene and epoxidized ABS.

(h) Linear or cyclic β-ketoesters and/or β-diketones and/or triketones and/or their metal salts.

(i) Hydrotalcites, for example as described in DE 4425266, EP 0189899, DE 3843581, U.S. 4,883,533, EP 0407139, DE 4031818, DE 4110835, DE 4117034, EP 0522810, DE 4439934 and U.S. Pat. No. 5,352,723.

(j) Zeolites such as those described by the general formula Mₓⁿ[(AlO₂)ₓ(SiO₂)_{y}].m H₂O, where n is the charge on the cation M and n=1 or 2, and M is an alkali metal or alkaline earth metal, and 0.8≦x; y≦15, and 0≦m≦300.

(k) Amino compounds, for example those selected from sterically hindered amines (HALS), aminocrotonic acid compounds, uracils, amino acids, and their alkali metal and alkaline earth metal salts.

(1) Hydrocalumites of the general formula AlCaₓ(OH)₍₂ₓ₊₃₎. m H₂O; x=1-4; m=0-8, for example as described in DE-A-4103881.

(m) Alkaline earth metal salts of saturated, unsaturated, straight-chain, or branched mono- or polyfunctional aromatic or aliphatic carboxylic acids.

The stabilizer combination of the invention may in addition comprise at least one lubricant. Examples of lubricants are those selected from paraffin waxes, polyethylene waxes, polypropylene waxes, ester lubricants, mono- and/or polyvalent alcohols, mono- and/or polycarboxylic acids, amide waxes, and oxidized polyethylene waxes. Lubricants are selected to meet rheological requirements.

The stabilizer combination of the invention may be in any desired physical form, e.g. as a pulverulent mixture, compressed pellets, sprayed pellets, or micropellets, or flakes or pastilles. These forms of the products may either be pelletized from pulverulent mixtures by pressure and/or heat, and/or by adding pelletizing auxiliaries, or be molded by cooling or spraying melts of the composition of the invention, to give flakes, pastilles, or prill. To prepare halogen-containing resin compositions, the individual substances may be added directly or as a mixture, in the abovementioned forms of the product, prior to or during processing.

The halogen-containing thermoplastic resin composition may then be molded in a manner known per se to give moldings.

The stabilizer combination of the invention may be used in combination with the additives usually used, for example fillers (e.g. chalk), pigments (e.g. titanium dioxide, zinc sulfide), flame retardants (e.g. magnesium hydroxide, aluminum hydroxide, antimony trioxide), reinforcing materials (e.g. glass fibers, talk, vegetable fibers), and plasticizers (e.g. phthalate, phosphate, and/or polymeric plasticizers, chloroparaffins) in the production of thermoplastic molding compositions.

The examples described below in mixing specification tables A and B illustrate the invention but do not restrict the same. Thermal stability in the examples is determined to DIN VDE 0472 Part 614 (HCl value). The aim here is to achieve the highest possible value. Weathering resistance is evaluated by measuring the b value (CIE-LAB system) after 24 months of open-air weathering in the south of France. The profiles had undergone some further darkening while in the mail for a number of days and were then subjected to seven further days of open-air weathering in Munich. To indicate good weathering resistance here the b value should be as low as possible, pointing to only slight yellow discoloration.

Processing:

The constituents of the mixing specification were mixed with the PVC and with other additives in a heating/cooling mixer until the mixing temperature reached 120° C., then cooled to 40° C. The resultant dry blend was then extruded to give profiles.

### EXAMPLE A

| | A1* | A2* | A3* | A4 | A5 | A6* | A7* | A8* | A9 | A10 |
|---|---|---|---|---|---|---|---|---|---|---|
| SPVC | 100 | 100 | 100 | 100 | 100 | 100 | 100 | 100 | 100 | 100 |
| Chalk¹⁾ | 5 | 5 | 5 | 5 | 5 | 5 | 5 | 5 | 5 | 5 |
| Impact | 7 | 7 | 7 | 7 | 7 | 7 | 7 | 7 | 7 | 7 |
| modifier²⁾ | | | | | | | | | | |
| TiO₂³⁾ | 5 | 5 | 5 | 5 | 5 | 5 | 5 | 5 | 5 | 5 |
| Flow promoter⁴⁾ | 1 | 1 | 1 | 1 | 1 | 1 | 1 | 1 | 1 | 1 |
| Paraffin wax | 0.9 | 0.9 | 0.9 | 0.9 | 0.9 | 0.9 | 0.9 | 0.9 | 0.9 | 0.9 |
| Oxidized PE wax | 0.8 | 0.8 | 0.8 | 0.8 | 0.8 | 0.8 | 0.8 | 0.8 | 0.8 | 0.8 |
| Calcium | 1.2 | 1.2 | 1.2. | 1.2 | 1.2 | 1.2 | 1.2 | 1.2 | 1.2 | 1.2 |
| stearate⁵⁾ | | | | | | | | | | |
| zinc stearate⁶⁾ | — | — | — | 0.25 | 0.5 | — | — | — | 0.25 | 0.5 |
| Calcium hydroxide | — | 0.5 | 1.0 | 0.25 | 0.5 | — | 0.5 | 1.0 | 0.25 | 0.5 |
| Tin | 1.5 | 1.0 | 0.5 | 1.0 | 0.5 | — | — | — | — | — |
| stabilizer⁷⁾ | | | | | | | | | | |
| Tin | — | — | — | — | — | 1.5 | 1 | 0.5 | 1.0 | 0.5 |
| stabilizer⁸⁾ | | | | | | | | | | |

*Comparative examples
¹⁾Hydrocarb 95 T (Omya trade name)
²⁾Bärodur E-ST 3 (Bärlocher trade name)
³⁾TiPure R 101 (DuPont trade name)
⁴⁾Bärorapid 10 F (Bärlocher trade name)
⁵⁾Ceasit 1 (Bärlocher trade name)
⁶⁾Zinkum 5 (Bärlocher trade name)
⁷⁾Advastab TM 181 (Morton trade name)
⁸⁾Bärostab M 25 S (Bärlocher trade name)

Table 1 shows the b values after weathering

TABLE 1

| Specimen | b-value |
|---|---|
| A1 | 7.2 |
| A2 | 7.5 |
| A3 | 7.7 |
| A4 | 4.6 |
| A5 | 4.1 |
| A6 | 7.1 |
| A7 | 7.6 |
| A8 | 8.0 |
| A9 | 4.3 |
| A10 | 3.9 |

It is clear that the mixtures A4-A5 and A9-A10 of the invention gave markedly lower values.

### EXAMPLE B

| | B1* | B2 | B3 |
|---|---|---|---|
| SPVC | 100 | 100 | 100 |
| Chalk¹⁾ | 3 | 3 | 3 |
| Impact modifier⁹⁾ | 7 | 7 | 7 |
| TiO₂¹⁰⁾ | 4.2 | 4.2 | 4.2 |
| Flow promoter¹¹⁾ | 1 | 1 | 1 |
| Paraffin wax | 0.75 | 0.75 | 0.75 |
| Oxidized PE wax | 0.15 | 0.15 | 0.15 |
| Calcium stearate | 1.5 | 0.5 | 1.0 |
| Zinc stearate⁶⁾ | — | 1.0 | 0.5 |
| Calcium hydroxide | — | 1.0 | 1.0 |
| Tin stabilizer¹²⁾ | 1.5 | 0.5 | 1.0 |

*Comparative example
⁹⁾Bärodur EST4 (Bärlocher trade name)
¹⁰⁾Kronos 2220 (Kronos trade name)
¹¹⁾Bärorapid (Bärlocher trade name)
¹²⁾Bärostab MSO (Bärlocher trade name)

Table 2 shows the HCl values to DIN VDE 0472 Part 614

TABLE 2

| Specimen | HCl value (min) |
|---|---|
| B1 | 22 |
| B2 | 32 |
| B3 | 30 |

It is clear that the mixtures B2 and B3 of the invention gave markedly higher values.

1. A stabilizer combination for halogen-containing thermoplastic resins, comprising:
a) calcium oxide and/or calcium hydroxide, where these, where appropriate, may have been surface-modified, and have a particle size of not more than 200 μm;
b) at least one tin compound of the general formula (I)
RₙSn(X—R′)₄₋ₙ (I)
where
n is 1 or 2;
each of the groups R, which may be identical or different, is a straight-chain or branched alkyl group having from 1 to 22 carbon atoms;
each of the groups X, which may be identical or different, is —S— or —O—; and
each of the groups R′, which may be identical or different, is a straight-chain or branched alkyl group having from 1 to 22 carbon atoms, or a —[C(O)]ₘ—L—C(O)—O—R″ group or a —[C(O)]ₘ—L—O—C(O)—R″ group, where m is 0 or 1, —L— is a divalent connecting group which is selected from alkylene groups having from 1 to 4 carbon atoms, or a vinylene group, and R″ is an alykl group having from 1 to 22 carbon atoms; or
two (X—R′) groups may have bonding to one another to form a heterocyclic ring of the formula (I′) or (I″) where L is as defined above; and
c) at least one zinc compound
with the proviso that no perchlorate is present in the stabilizer combination.

2. A stabilizer combination as claimed in claim 14, wherein the amount of component (a) present is from 0.1 to 5 parts by weight.

3. A stabilizer combination as claimed in claim 14, wherein component (b) is at least one tin compound of the formula (I), where R is an alkyl group having from 1 to 8 carbon atoms.

4. A stabilizer combination as claimed in claim 14, characterized in that component (b) is at least one tin compound of the formula (I), where R′ is an alkyl group having from 8 to 18 carbon atoms, or a —[C(O)]ₘ—L—C(O)—O—R″ group or a —[C(O)]_{m—L—O—C(O)—R″ group, where —L—is a methylene, ethylene, or vinylene group, and R″ is an alkyl group having from} 6 to 12 carbon atoms.

5. A stabilizer combination as claimed in claim 14, characterized in that component (b) is at least one tin compound of the formula (I), where two (X—R′) groups have bonding to one another to form a heterocyclic ring of the formula (I′) or (I″), where —L— is an ethylene group or a vinylene group.

6. A stabilizer combination according to claim 14, characterized in that the amount of component (b) present is from 0.1-3 parts by weight.

7. A stabilizer combination according to claim 14, characterized in that component (c) is a zinc salt of a saturated aliphatic carboxylic acid having from 10 to 18 carbon atoms.

8. A stabilizer combination as claimed in claim 14, characterized in that the amount of component (c) present is from 0.1 to 3 parts by weight.

9. A thermoplastic resin composition, comprising at least one halogen-containing thermoplastic resin and a stabilizer combination according to claim 14.

10. A thermoplastic resin composition according to claim 22, characterized in that the halogen-containing thermoplastic resin is polyvinyl chloride.

11. A method of stabilizing a halogen-containing thermoplastic resin, the method comprising adding a stabilizer combination according to claim 14 to a halogen-containing thermoplastic resin.

12. The method according to claim 27, wherein the resin comprises polyvinyl chloride (PVC).

13. The method according to claim 27, wherein the resin comprises rigid PVC (UPVC).

14. The method of claim 14, wherein the zinc compound is selected from the group consisting of a zinc salt having from 10 to 18 carbon atoms, zinc oxide and zinc hydroxide.

15. The method of claim 14, wherein the zinc compound is selected from the group consisting of a zinc salt of a saturated aliphatic carboxylic acid having from 10 to 18 carbon atoms, zinc oxide and zinc hydroxide.
